(19) United States
(12) Patent Application Publication
(10) Pub. No.: US 2009/0060079 A1
(43) Pub. Date: Mar. 5, 2009

(54) METHOD FOR DETECTING A SYMBOL USING TRELLIS STRUCTURE ON THE MULTIPLE INPUT MULTIPLE OUTPUT MOBILE COMMUNICATION SYSTEM

(75) Inventors: Sang Ho CHOI, Ulsan (KR); Young Chai Ko, Seoul (KR); Jun Heo, Seoul (KR); Byung Gueon Min, Gyeonggi-do (KR)

Correspondence Address: RABIN & Berdo, PC, 1101 14TH STREET, NW, SUITE 500, WASHINGTON, DC, 20005, US

(73) Assignee: Mewtel Technology Inc., Seoul (KR)

(21) Appl. No.: 11/934,482

(22) Filed: Nov. 2, 2007

(30) Foreign Application Priority Data
Aug. 31, 2007 (KR) 10-2007-0088581

(51) Int. Cl. H04L 23/02

(52) U.S. Cl. 375/265

(57) ABSTRACT

Disclosed is a method for detecting a symbol using a trellis structure on a multiple input multiple output (MIMO) mobile communication system. The method includes the steps of: setting a plurality of states by grouping symbols producible from a receiving signal in the unit of sub-states; calculating metric values for paths inputted to the sub-states and selecting paths having the calculated metric values smaller than a preset first threshold, as first surviving paths; setting a second threshold based on an accumulated metric value of a path having the smallest accumulated metric in each of the states; and selecting paths having metric value smaller than the second threshold, as second surviving paths, among the first surviving paths selected for each state.

### TECHNICAL FIELD

The present invention relates to a method for detecting a symbol on a mobile communication system, and more particularly, to a method for detecting a symbol on a multiple input multiple output mobile communication system.

### BACKGROUND ART

The most critical issue in communication is the transmission efficiency and reliability of data through a channel. In the next generation multimedia mobile communication system which has been actively studied in recent years, as there has been a need of a high speed communication system for processing and transmitting a variety of information including video, radio data, etc as well as providing earlier voice-centered services, it is essential to raise a system efficiency using a channel coding scheme appropriate to the system.

In the mean time, unlike wired channel environments, in mobile channel environments existing in a mobile communication system, unavoidable errors occur due to various factors such as multipath interference, shadowing, EM wave attenuation, time-variable noise, fading and so on, which results in loss of information.

The information loss causes an actual transmission signal to be greatly distorted, which results in deterioration of the overall performance of the mobile communication system. In general, in order to reduce such information loss, system reliability is raised using various error-control techniques depending on characteristics of channels. Among these techniques, the most essential technique is to use an error-correcting code.

In addition, a diversity scheme is used to eliminate communication unstability due to the fading effect. The diversity scheme may be generally classified into a time diversity scheme, a frequency diversity scheme, and an antenna diversity scheme (i.e., space diversity).

The antenna diversity scheme, which uses a multiple antenna, may be classified into a receiving antenna diversity scheme using a plurality of receiving antennas, a transmitting antenna diversity scheme using a plurality of transmitting antennas, and a multi input multi output (MIMO) scheme using a plurality of receiving antennas and a plurality of transmitting antennas. FIG. 1 is a block diagram showing a transmitter/receiver structure of a general MIMO system.

Great attention has been paid to the shown MIMO system because it increases diversity gain and data rate in mobile communication. However, since the performance of the MIMO system depends highly on a receiving signal detection method, MIMO receiving signal detection, which is one of factors important in the MIMI system, has been raised as critical issues.

While the maximum likelihood detection (MLD) is optimum in terms of the receiving signal detection performance in the MIMI system, the MLD has prohibitive complexity to implement. In particular, the complexity of MLD is exponentially increasing as the number of antennas and/or the constellation size increase since it needs to make an exhaustive search over all the possible transmitted symbol combinations.

As such, some suboptimal approach such as zero forcing detection (ZFD), minimum mean square error detection (MMSED), and some variants of ZFD and MMSED have been presented. However, although the complexity of ZFD and MMSED is much reduced as compared to the MLD, the performance of ZFD and MMSED is often unacceptable, in particular, for the system to require high data rate.

Recently, the MLD with QR decomposition and M-algorithm (QRM-MLD) has been proposed, where the performance is near the performance of MLD but with quite reduced complexity as compared to the optimal MLD. The QRM-MLD basically selects a certain limited number of surviving set of paths at each MIMO detection stage according to the threshold, unlike the optimal MLD.

Note that it has been known in VLSI implementation that a delay time is inversely proportional to power consumption. Therefore, in case of saving the power, a certain finite number of parallel functions is used, instead of the serial functions, in order to compensate for longer delay time resulting from the reduction of the power consumption. As such, the operational frequency is maintained to some extent. This approach is often adopted for the channel decoding to reduce the power consumption. In addition to parallelism, regularity in an algorithm, which refers to the repeated occurrence of computational patterns, can reduce the power consumption.

However, the above-described conventional QRM-MLD using the tree-structure as shown in FIG. 2 still requires high complexity for the implementation mainly due to the lack of parallelism and regularity in the decoding structure which are critical factors for low-power and consumption and high speed VLSI (Very Large Scale Integration) implementation.

### DISCLOSURE

### Technical Problem

It is an object of the invention to provide a method for detecting a symbol using a trellis structure on a multiple input multiple output (MIMO) mobile communication system, which is capable of securing high parallelism and regularity by applying the trellis structure to a QRM-MLD scheme in detecting the symbol received in the MIMO mobile communication system.

It is another object of the invention to provide a method for detecting a symbol using a trellis structure on a multiple input multiple output (MIMO) mobile communication system, which is capable of lowering complexity for VLSI implementation by applying the trellis structure to a QRM-MLD scheme in detecting the symbol received in the MIMO mobile communication system.

### Technical Solution

To accomplish the above objects, the present invention provides a method of detecting a symbol using a trellis structure on a multi input multi output mobile communication system, including the steps of: setting a plurality of states by grouping symbols producible from a receiving signal in the unit of sub-states; calculating metric values for paths inputted to the sub-states and selecting paths having the calculated metric values smaller than a preset first threshold, as first surviving paths; setting a second threshold based on an accumulated metric value of a path having the smallest accumulated metric in each of the states; and selecting paths having metric value smaller than the second threshold, as second surviving paths, among the first surviving paths selected for each state.

Preferably, the method is repeatedly performed for each of a plurality of stages, and the symbol is determined by finally selecting the path having the smallest accumulated metric among surviving paths remaining at the final stage.

Preferably, the number of stages for which the method is repeatedly performed is equal to the number of transmitting antennas, and the number of transmitting antennas is equal to or larger than the number of receiving antennas.

Preferably, the metric values for the paths inputted to the sub-states are calculated based on the squared Euclidian distance between the receiving signal and the symbol.

Preferably, the metric values for the paths inputted to the sub-states are calculated according to the following equation.

|z₁−rₙ_{_{T}}_{,n}_{_{T}}cₓ|², where 1≦x≦M

where, R and z are represented as the following equation, and cx represents all the possible symbols for finding candidate symbols.

$$R = [ \begin{matrix}{r}_{1 , 1} & {r}_{1 , 2} & K & {r}_{1 , {n}_{T}} \\ 0 & {r}_{2 , 2} & & M \\ M & O & O & {r}_{{n}_{T} - 1 , {n}_{T}} \\ 0 & K & 0 & {r}_{{n}_{T} , {n}_{T}}\end{matrix} ]$$

$$z = {Q}^{H} y = {[ \begin{matrix}{z}_{{n}_{T}} & {z}_{{n}_{T} - 1} & L & {z}_{1}\end{matrix} ]}^{T}$$

Preferably, the first threshold is calculated according to the following equation.

Tᵢ=|zᵢ−Rₙ_{_{T}}₋₍ᵢ₋₁₎ŝ|+Xσ

where, is Rₙ_{_{T}}₋₍ᵢ₋₁₎ is (nT−(i−1))th row vector in the following equation;

$$R = [ \begin{matrix}{r}_{1 , 1} & {r}_{1 , 2} & K & {r}_{1 , {n}_{T}} \\ 0 & {r}_{2 , 2} & & M \\ M & O & O & {r}_{{n}_{T} - 1 , {n}_{T}} \\ 0 & K & 0 & {r}_{{n}_{T} , {n}_{T}}\end{matrix} ]$$

and, when c is vector composed of M nT×1 sized constellations ŝ is represented as the following equation;

$$\hat{s} = {\text{arg} min}_{c} ‖ {( {R}^{H} R )}^{- 1} {R}^{H} z - c ‖$$

Preferably, X in the equation is predetermined in consideration of the performance and complexity of the system.

Preferably, σ is a noise standard deviation and is defined by the following equation.

$$\frac{{E}_{b}}{{N}_{0}} = \frac{{n}_{R}}{b} \cdot \frac{{E}_{s}}{{N}_{0}}$$

where, the above equation represents the total received Eb/N0 per transmitting antenna, b is the required number of bits per symbol, and Eb and Es are energy per bit and symbol, respectively.

Preferably, at the i-th stage, the accumulated metric values of a set of new candidate symbols ([cX, cX′]) obtained through combination of a set of di−1 previous candidate symbols transferred from the previous stage and candidates of M i-th symbols (si) are calculated according to the following equation.

|zᵢ−Rₙ_{_{T}}_{-i+1,n}_{_{T}}_{-i+1:n}_{_{T}}[cₓ,c_{x′}]^{T}|²+E_{x′},
where 1≦x≦M, 1≦x′≦dᵢ₋₁

where, Rₙ_{_{T}}₋ᵢ₊1,n_{_{T}}₋ᵢ₊1:n_{_{I}} denotes vector with elements from the (nT−i+1)th to the (nT)th in the (nT−i+1)th row of R, and cX′ denotes a set of candidate symbols transferred from the previous stage.

Preferably, the second threshold is determined based on an accumulated metric value of the path with the smallest accumulated metric in each state in consideration of a noise standard deviation, and the second threshold at the j-th state in the i-th stage is calculated according the following equation.

G_{i,j}=E_{(i,j),min}+Yσ

where, E(i,j),min is the smallest accumulated metric value of paths at the j-th state in the i-th stage.

Preferably, Y in the equation is predetermined in consideration of the performance and complexity of the system, and σ is a noise standard deviation and is defined by the following equation.

$$\frac{{E}_{b}}{{N}_{0}} = \frac{{n}_{R}}{b} \cdot \frac{{E}_{s}}{{N}_{0}}$$

where, the above equation represents the total received Eb/N0 per transmitting antenna, b is the required number of bits per symbol, and Eb and Es are energy per bit and symbol, respectively.

Preferably, the step of selecting paths having metric value smaller than the second threshold, as second surviving paths comprises the step of, if any path that satisfies the second threshold does not exist at a particular state, selecting paths with the smallest accumulated metric in the state, as the second surviving paths.

Preferably, the step of selecting paths having metric value smaller than the second threshold, as second surviving paths comprises the step of, if the number of paths that satisfies the second threshold at a particular state is larger than the number of sub-metrics of the state, selecting paths in the state, as the second surviving paths by the number of sub-metrics in descending order of accumulated metrics in the state.

### ADVANTAGEOUS EFFECTS

According to the method of the invention, high parallelism and regularity can be secured by applying the trellis structure to QRM-MLD in detecting the symbol received in the MIMO mobile communication system, which results in reduced power consumption and high operation speed in VLSI implementation. That is, it is possible to facilitate VLSI implementation bt improving the prallelism and regularlity using the proposed trellis-structured QRM-MLD.

In addition, by applying two thresholds to select paths with high reliability, the proposed trellis-structured QRM-MLD can have significantly reduced computational complexity for MIMI detection and low performance deterioration as compared to MLD.

### DESCRIPTION OF THE DRAWINGS

FIG. 1 is a block diagram showing a transmitter/receiver structure of a general MIMO system.

FIG. 2 is a view showing a QRM-MLD method employing a tree-structure adopted for receiving symbol detection in a conventional MIMO system.

FIG. 3 is a view showing a QRM-MLD method employing a trellis-structure according to an embodiment of the invention.

FIG. 4 is a graph showing an example of selection of a path according to a threshold at each stage according to an embodiment of the invention.

FIG. 5 is a flow chart showing a QRM-MLD procedure of a trellis-structure according to an embodiment of the invention.

FIG. 6 is a graph showing comparison of BER performances in application of a trellis-structure to QRM-MLD according to an embodiment of the invention.

FIG. 7 is a graph showing comparison of the number of times of computation in application of a trellis-structure to QRM-MLD according to an embodiment of the invention.

### MODE FOR INVENTION

In symbol detection of a MIMO system, a QRM-MLD scheme has performance near the optimal MLD and lower complexity than the optimal MLD. However, the above-described conventional QRM-MLD scheme has much difficulty in actually implementing VLSI due to the lack of parallelism and regularity in a decoding process, as described above.

Accordingly, in the invention, a trellis-structure based on a viterbi algorithm is used to obtain high parallelism and regularity for effective VLSI implementation, without using the tree-structure in the conventional QRM-MLD.

In addition, in embodiments of the invention, using two different thresholds in application of the trellis-structure, the number of surviving paths is decreased to lower complexity while securing the performance of the conventional QRM-MLD.

In the following description, a MIMO system to which the invention is applied and QRM-MLD adopted for symbol detection in the MIMO system will be first described in brief, and then, a MIMO detecting algorithm using the trellis-structure proposed by the invention will be described in detail.

<MIMO System and Channel Model>

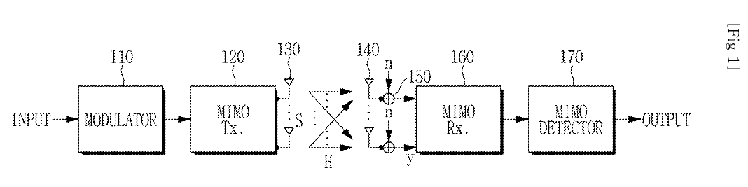

FIG. 1 is a block diagram showing a transmitter/receiver structure of a general MIMO system.

Referring to FIG. 1, input data to be transmitted is modulated in a modulator 110, and then transmitted from a MIMO transmitter 120 to a wireless channel via nT transmitting antennas 130. The transmitted data are received in nR receiving antennas 140, mixed 150 with noises, and inputted to a MIMO receiver 160. A MIMO detector 170 detects the original data (that is, the input data) from the a signal outputted from the MIMO receiver 160. In this case, the number of the receiving antennas is equal to or larger than the number of the transmitting antennas (nT≦nR).

The MIMO system of FIG. 1 adopts spatial multiplexing signaling (that is, the signals transmitted from multiple antennas are independent each other) and M-QAM modulation with M=2b, where M is the number of constellations in modulation and b is the number of bits per symbol. When s denotes transmitted symbol vector with the size of nT×1, to be passed through the Rayleigh fading channel with the nR×nT channel matrix H, and y denotes received symbol vector with the size of nR×1, the MIMO system can be expressed by the following Equation 1.

y=Hs+n [Equation 1]

where, n is a nR×1 additive white gaussian noise (AWGN) vector with zero mean and variance (σ2) of N0/2, and

s=[sₙ_{_{T}},sₙ_{_{T}}₋₁,L,s₁]^{T}

The QRM-MLD scheme adopted to detect the symbol vector s of the MIMO system is as follows.

Taking the QR decomposition into the nR×nT channel matrix H, H can be presented as the following Equation 2

H=QR′ [Equation 2]

where, Q is unitary matrix with the size of nR×nR and R′ is represented by the following Equation 3

$${R}^{′} = [ \begin{matrix}R \\ {0}_{( {n}_{R} - {n}_{T} ) \times {n}_{T}}\end{matrix} ] \qquad [ Equation 3 ]$$

where, R is an nT×nT upper triangular matrix and Oₙ_{_{R}}ₙ_{_{T}}_{)×n}_{_{I}} is a zero matrix with the size of (nR−nT)×nT.

Using QHQ=1 and multiplying both sides of Equation 1 by QH, Equation 1 is changed to the following Equation 4

$$z = Rs + {n}^{′} = R [ \begin{matrix}{s}_{{n}_{T}} \\ {s}_{{n}_{T} - 1} \\ M \\ M \\ {s}_{1}\end{matrix} ] + [ \begin{matrix}{n}_{{n}_{T}}^{′} \\ {n}_{{n}_{T} - 1}^{′} \\ M \\ M \\ {n}_{1}^{′}\end{matrix} ] \qquad [ Equation 4 ]$$

where, R, z and n′ are represented by the following Equations 5, 6 and 7, respectively.

$$\begin{matrix}R = [ \begin{matrix}{r}_{1 , 1} & {r}_{1 , 2} & K & {r}_{1 , {n}_{T}} \\ 0 & {r}_{2 , 2} & & M \\ M & O & O & {r}_{{n}_{T} - 1 , {n}_{T}} \\ 0 & K & 0 & {r}_{{n}_{T} , {n}_{T}}\end{matrix} ] & [ Equation 5 ] \\ z = {Q}^{H} y = {[ \begin{matrix}{z}_{{n}_{T}} & {z}_{{n}_{T} - 1} & L & {z}_{1}\end{matrix} ]}^{T} & [ Equation 6 ] \\ {n}^{′} = {Q}^{H} n & [ Equation 7 ]\end{matrix}$$

Next, the operation of the M-algorithm will be described. First, at the first stage, metric values for all the possible symbols (cx, 1≦x≦M) are calculated to find symbol candidates for the first symbol s1. In this case, as represented by the following Equation 8, the squared Euclidian distance between z and symbols is assumed to be metric values.

|z₁−rₙ_{_{T}}_{,n}_{_{T}}cₓ|², where 1≦x≦M [Equation 8]

d1 candidate symbols and their accumulated metric values are transferred to the next stage in descending order of metric values obtained from the above Equation 8.

Hereinafter, from the second stage, the decoding process can be generalized to the i-th stage (2≦i≦nT). At the i-th stage, accumulated metric values of a set of new candidate symbols ([cX, cX′]) obtained through combination of a set of di−1 previous candidate symbols transferred from the previous stage and candidates of M i-th symbols si are calculated according to the following Equation 9.

|zᵢ−Rₙ_{_{T}}_{-i+1,n}_{_{T}}_{-i+1:n}_{_{T}}[cₓ,c_{x′}]^{T}|²+E_{x′}, [Equation 9]
where 1≦x≦M, 1≦x′≦dᵢ₋₁

where, Ex′ is an accumulated metric value that is transferred from the previous stage along with the candidate symbol sets cX′.

In Equation 9, Rₙ_{_{T}}_{-i+1,n}_{_{T}}_{-i+1:n}_{_{I}} denotes vector with elements from the (nT−i+1)th to the (nT)th in the (nT−i+1)th row of R, and cX′ denotes a set of candidate symbols transferred from the previous stage.

The total number of sets of candidate symbols [cX, cX′] including the total number i of candidate symbols from the first to i-th symbol is Mdi−1. Among those sets, only di candidate symbol sets with small accumulated metric values obtained from the above Equation 9 are transferred to the (i+1)th stage along with their accumulate metric values.

Similarly, the above process is repeated up to the final nT stage where accumulated metric of new candidate symbol sets obtained through combinations of paths, which survive throughout all the previous stages, and current symbols Sₙ_{_{T}} is calculated, and hard decision symbols are obtained based on one combination with the smallest accumulated metric.

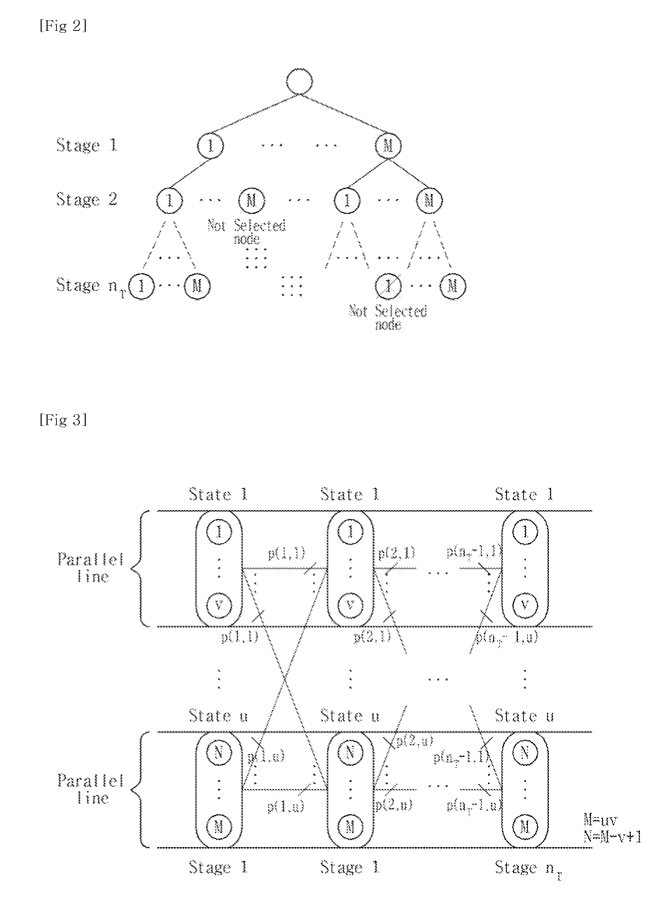

As described above, the MLD is composed of tree-structure with nT stages, and all the paths in the tree-structure are considered as candidates to determine exact symbols, as shown in FIG. 2. The conventional QRM-MLD is also composed of tree-structure as shown in FIG. 2. However, the conventional QRM-MLD searches only some selected paths instead of all the paths. Accordingly, although the conventional QRM-MLD has less complexity than that of MLD, it still has low parallelism/regularity since it is still tree-structured symbol detection as mentioned above.

Hereinafter, a method of applying the proposed trellis-structure to the QRM-MLD in the above MIMO system will be described in detail. In the following detailed description, concrete description on related functions or constructions will be omitted if it is deemed that the functions and/or constructions may unnecessarily obscure the present invention.

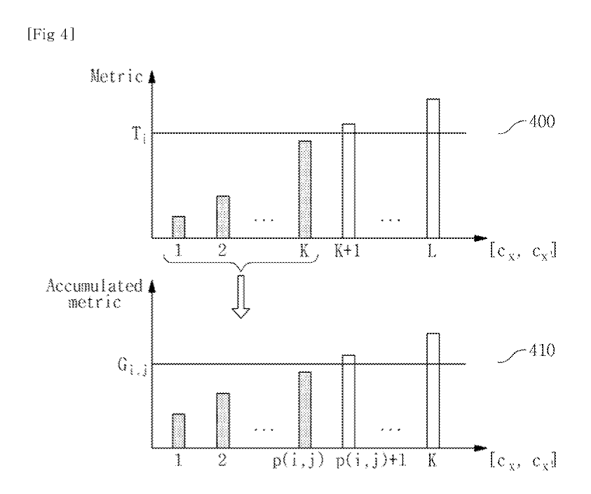

In the present invention, as shown in FIG. 3, a trellis-structured QRM-MLD is constructed by applying the trellis-structure used in the viterbi algorithm to the above-mentioned QRM-MLD.

Hereinafter, three parameters to be used for the trellis-structure to be applied to the QRM-MLD.

1. u: the number of states in trellis-structured QRM-MLD (group of v states)

2. v: the number of sub-states per each state in trellis-structured QRM-MLD (group of v states). (Therefore, M=u□v)

3. p(i,j)(1≦i≦nT, 1≦j≦u): the required number of surviving paths from each state in the i-th stage to the (i+1)th stage. Then, the total number of surviving paths from the i-th stage to the (i+1)th stage is Σjp(i,j).

Note that the proposed trellis-structured QRM-MLD differs from the conventional QRM-MLD in that the number of surviving paths varies in every stage and state. In the conventional QRM-MLD, a certain number of paths are selected as surviving paths at all the states. On the other hand, the proposed trellis-structured QRM-MLD can assign the number of different surviving paths at each state, which is more efficient than the conventional QRM-MLD and will be described in detail later.

FIG. 3 is a view showing a QRM-MLD method employing a trellis-structure according to an embodiment of the invention. Referring to FIG. 3, the total number M of states are constructed into u groups of states, each group having v states (hereinafter, the state groups, each including a plurality of states, will be re-defined as states in the trellis-structure), and each of v states constructing each of u state groups is referred to as a sub-state. In other words, each of u state groups is composed of v sub-states, and accordingly, the total number of sub-states is v×u=M. Since the states grouped so form a parallel line according to the trellis-structure to search paths, it is possible to obtain parallelism and regularity.

Hereinafter, a method of selecting different number of surviving paths at each state will be described in detail. In the present invention, two different thresholds are used to select surviving paths at each state.

FIG. 4 is a graph showing an example of selection of a path according to a threshold at each stage according to an embodiment of the invention.

In FIG. 4, the first threshold Ti of two thresholds at the i-th stage is calculated according to the following Equation 10.

Tᵢ=|zᵢ−Rₙ_{_{T}}₋₍ᵢ₋₁₎ŝ|+Xσ [Equation 10]

where, Rₙ_{_{T}}₋₍ᵢ₋₁₎ is (nT−(i−1))th row vector in the above Equation 5. When c is vector composed of M nT×1 sized constellations ŝ can be represented as the following Equation 11.

$$\hat{s} = {\text{arg} min}_{c} ‖ {( {R}^{H} R )}^{- 1} {R}^{H} z - c ‖ \qquad [ Equation 11 ]$$

In Equation 10, X is a predetermined value, and σ is noise standard deviation and is obtained from Eb/N0 as defined in the following Equation 12.

$$\frac{{E}_{b}}{{N}_{0}} = \frac{{n}_{R}}{b} \cdot \frac{{E}_{s}}{{N}_{0}} \qquad [ Equation 12 ]$$

The above Equation 12 represents the total received Eb/N0 per transmitting antenna, where b is the required number of bits per symbol, and Eb and Es are energy per bit and symbol, respectively.

As shown in the upper graph 400 of FIG. 4, in the i-th stage, paths K having metric values smaller than those in Equation 10 are first selected from paths L produced by combinations of paths, which enter the i-th stage for each state, and sub-states.

A boundary provided by Equation 10 in a high SNR region is even more reliable than that provided in a low SNR region. This is because the probability that ŝ is the same as the symbol vector transmitted from the transmitter is getting higher as the SNR increases. Then, due to the second term in Equation 10, the higher SNR provides the smaller boundary, and it is preferable to set the boundary to select the more reliable surviving paths.

In the above Equation 10, the parameter X, which is defined by a user, is a value having a tradeoff between performance and computational complexity. In the case of large value of X, the performance can be improved by reducing the miss-path selection probability at the cost of increased computational complexity. On the other hand, in the case of small value of X, the performance can be deteriorated although the computational complexity can be reduced.

Hereinafter, according to an embodiment of the invention, a method of selecting surviving paths at each state using the first threshold defined above and the second threshold which will be described later will be described.

First, surviving paths to be transferred to the (i+1)th stage for each state among paths passing through the first threshold are selected through the second threshold. At that time, the second threshold at the j-th state of the i-th stage is calculated according to the following Equation 13.

G_{i,j}=E_{(i,j),min}+Yσ [Equation 13]

where, E(i,j),min is the smallest accumulated metric value of paths at the j-th state in the i-th stage. Y is a predetermined value such as X in the first threshold (i.e., Equation 10), and σ is noise standard deviation obtained from Equation 12.

As shown in the lower graph 410 of FIG. 4, at each state in the i-th stage, paths p(i,j) having accumulated metric smaller than the second threshold (i.e, Equation 13) are finally selected from the paths K passing through the first threshold, and then transferred to the (i+1)th stage.

At this time, the probability that the surviving paths having values smaller than Equation 13 are composed of the symbols actually transmitted from the transmitter is larger than P(i,j),min/e(Y/σ). Where, P(i,j),min is the probability that the surviving paths having E(i,j),min values are composed of symbols actually transmitted from the transmitter.

In the above probability, like X, Y provides a tradeoff between performance and computational complexity. That is, as values of X and Y are larger, the performance can be improved at the expense of an increase in computational complexity.

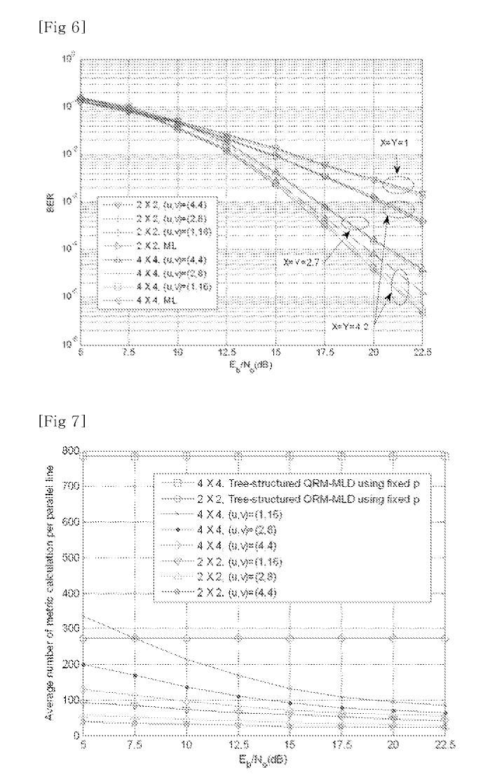

It is difficult to find the optimal values of X and Y for the performance and complexity according to several communication conditions (the number of transmitting/receiving antennas, the number of states, the number of sub-states, etc.). Therefore, it is desirable to find proper X and Y values based on the communication conditions through a simulation. FIG. 6 demonstrates how the X and Y have an effect on the performance by setting values of X and Y variously.

To stop increasing the computational complexity, at each state, v surviving paths are selected at most even though the number of paths that are satisfied with the two thresholds is more than v.

In addition, if any path that is passed through the two thresholds does not exist at any state of the i-th stage, only one surviving path with the smallest accumulated metric (that is, the path with E_{(i,j),min} value in equation 13) among

$$v \cdot {\sum }_{j} p ( i - 1 , j )$$

paths generated by incoming paths from the previous stage in any state is selected and transferred to the next stage.

In this manner, the algorithm is executed such that surviving paths in all states at each stage are found and transferred to the next stage. At the final nT-th stage, one final path with the smallest accumulated metric is selected among

$${\sum }_{j} p ( {n}_{T} , j )$$

surviving paths, and b□nT bits along with this final path are hared decision output.

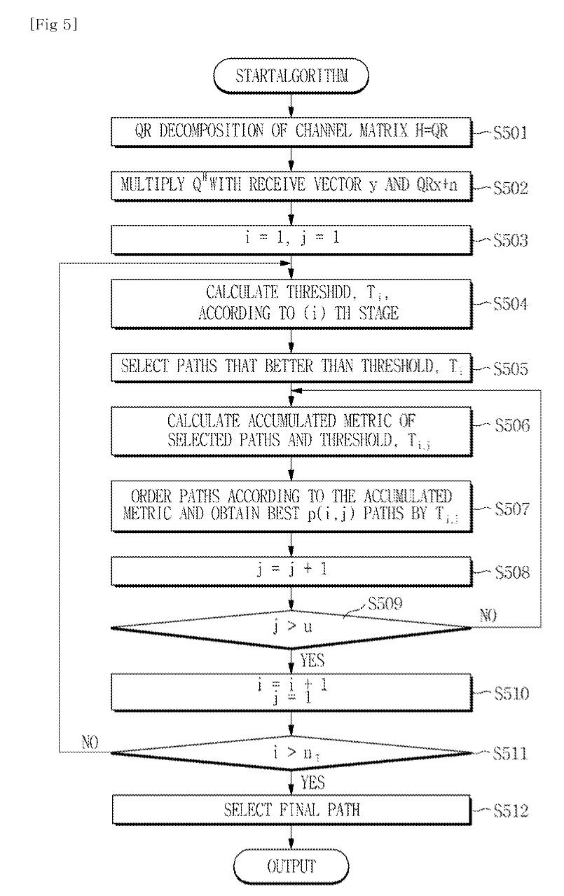

FIG. 5 is a flow chart showing a QRM-MLD procedure of the trellis-structure according to an embodiment of the invention. Referring to FIG. 5, as described above, for QRM-MLD application, the channel matrix is QR-decomposed (H=QR) (S501), and then, both sides (i.e., y and QRx+n) of the above Equation 1 are multiplied by QH (S502).

Then, i (stage) and j (state) are initialized to 1 (S503), and surviving paths are determined by calculating metric in each state for each stage based on the above-mentioned two thresholds. At this time, a plurality of states are grouped, and the thresholds are applied to the grouped states according to the embodiment of the invention.

Specifically, the first threshold Ti is calculated at the i-th stage according to the above Equation 10 (S504), and paths with metric smaller than the first threshold are selected among paths incoming paths into each sub-state in the i-th stage (S505).

Then, the accumulated metric of the selected paths and the second threshold Gi,j are calculated (S506). The paths are arranged according to the calculated accumulated metric, and the optical p(i,j) path based on the second threshold is acquired (S507).

In other words, as described above, when surviving paths that are passed through the first threshold are first determined, surviving paths satisfying the second threshold among the remaining surviving paths that are not passed through the first threshold are selected. At this time, the second threshold is applied to each state, and surviving paths are selected in at least one sub-state for each state.

Accordingly, as described above, the second threshold is calculated for each state and is applied to the surviving paths that are first passed through the first threshold. With the application of the second threshold, based on the paths with the smallest accumulated metric in each state as shown in Equation 13, paths whose accumulated metric is included in a preset difference (Yσ) are selected as surviving paths.

At this time, as described above, at least one surviving path for each state (i.e., a surviving path in a sub-state having the minimum accumulated metric) is selected, and the number of surviving paths for each state is limited not to exceed v.

The above process is carried out (S504 to S507) for states in all the stages (S508 to S510), and when the process is completed up to the final stage (S511), the final path is selected (S512).

In the mean time, the parameters such as u, v, and p(i,j) are important factors to adjust a tradeoff between performance, operation speed and computational complexity. Accordingly, more surviving paths

$${\sum }_{j} p ( i , j )$$

existing in the i-th stage provide better performance. In addition, when

$${\sum }_{j} p ( i , j )$$

has constant values, less u values provide better performance.

On the other hand, as the number of surviving paths incoming from the previous stage in each state increases, computational complexity increases because all metrics for the surviving paths have to be found. That is, the larger a value of

$${\sum }_{j} p ( i , j ) ,$$

the more the complexity. The metric computational complexity is proportional to O(N), and sorting using a quick sort algorithm executed to select paths increase in its complexity in proportion to O(N log 2N). Where, N is the number of paths.

In addition, the u value has to increase to obtain high operation speed VLSI since u parallel lines perform an independent detection operation simultaneously.

### EMBODIMENT

Hereinafter, simulation results to illustrate the performance and computational complexity of the trellis-structured QRM-MLD of the invention will be described. In the following embodiment, it is assumed that a channel is a block fading channel and the channel coefficients are generated according the Rayleigh distribution and are constant for a period of one symbol transmission time slot at the transmitter.

For example, a channel gain is constant over nT transmitted symbols. In this simulation, it is considered that the number of transmitting/receiving antennas of the MIMO system is 2 and 4 with 16-QAM modulation and it is assumed that perfect channel state information at the receiver is available.

FIG. 6 shows the performance of the trellis-structured QRM-MLD of the invention for several u and v values. In this figure, X and Y are set to 1, 2.7 and 4.2. The curves in FIG. 6 are obtained when surviving paths are selected by applying the two thresholds as mentioned above. It can be seen from FIG. 6 that QRM-MLD has a slight performance deterioration as compared to the performance of MLD. This is because two thresholds for selecting paths result in deprivation of opportunities for searching the paths. Instead, it can be seen that the complexity in sorting and calculating metrics is significantly reduced.

FIG. 7 shows the average number of metric calculation per parallel line according to the SNR. The complexity represented by the y-axis in FIG. 7 is obtained by the average number of metric calculation per parallel line in the above Equations 8 and 9 that are calculated for determining all the symbols which are transmitted during one transmission time slot.

The average number of metric calculation is an average of values obtained through 10,000 simulation results. In FIG. 7, X and Y are set to 4.2.

For the conventional tree-structured QRM-MLD using the fixed number of surviving paths, the average number of metric calculation, calculated as M+p□M□(nT−1), is constant and larger than that of the trellis-structured QRM-MLD over all the SNR regions.

In contrast, the average number of metric calculation per parallel line in the trellis-structured QRM-MLD for each (u,v) case converges to M+u□M□(nT−1)/u as the SNR increases to infinity. The reason for converging to the certain number is that the average number of surviving paths from the each sub-state to the next stage is reduced to the only one as the SNR increases to infinity.

Over all the SNR regions, the average number of metric calculation per parallel line in the trellis-structured QRM-MLD for the (u,v)=(1,16) case will be decreased to approximately 8% of that of the tree-structured QRM-MLD using the fixed number of surviving paths, p, in the 4×4 MIMO system with 16-QAM modulation.

Also, it can be seen from FIG. 7 that the average number of metric calculation per parallel line in the trellis-structured QRM-MLD is reduced as the number of states in the trellis-structured QRM-MLD increases. The low average number of metric calculation per parallel line leads to increase of the operation speed in VLSI implementation.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

1. A method of detecting a symbol using a trellis structure on a multi input multi output mobile communication system, comprising the steps of:
setting a plurality of states by grouping symbols producible from a receiving signal in the unit of sub-states;
calculating metric values for paths inputted to the sub-states and selecting paths having the calculated metric values smaller than a preset first threshold, as first surviving paths;
setting a second threshold based on an accumulated metric value of a path having the smallest accumulated metric in each of the states; and
selecting paths having metric value smaller than the second threshold, as second surviving paths, among the first surviving paths selected for each state.

2. The method according to claim 1, wherein the method is repeatedly performed for each of a plurality of stages.

3. The method according to claim 2, wherein the symbol is determined by finally selecting the path having the smallest accumulated metric among surviving paths remaining at the final stage.

4. The method according to claim 2, wherein the number of stages for which the method is repeatedly performed is equal to the number of transmitting antennas.

5. The method according to claim 4, wherein the number of transmitting antennas is equal to or larger than the number of receiving antennas.

6. The method according to claim 1, wherein the metric values for the paths inputted to the sub-states are calculated based on the squared Euclidian distance between the receiving signal and the symbol.

7. The method according to claim 6, wherein the metric values for the paths inputted to the sub-states are calculated according to the following equation.

|z₁−rₙ_{_{T}}_{,n}_{_{T}}cₓ|², where 1≦x≦M
where, R and z are represented as the following equation, and cx represents all the possible symbols for finding candidate symbols.
$$\begin{matrix}R = [ \begin{matrix}{r}_{1 , 1} & {r}_{1 , 2} & K & {r}_{1 , {n}_{T}} \\ 0 & {r}_{2 , 2} & & M \\ M & O & O & {r}_{{n}_{T} - 1 , {n}_{T}} \\ 0 & K & 0 & {r}_{{n}_{T} , {n}_{T}}\end{matrix} ] \\ z = {Q}^{H} y = {[ \begin{matrix}{z}_{{n}_{T}} & {z}_{{n}_{T} - 1} & L & {z}_{1}\end{matrix} ]}^{T}\end{matrix}$$

8. The method according to claim 1, wherein the first threshold is calculated according to the following equation.
Tᵢ=|zᵢ−Rₙ_{_{T}}₋₍ᵢ₋₁₎ŝ|+Xσ
where, Rₙ_{_{T}}₋₍ᵢ₋₁₎ is (nT−(i−1))th row vector in the following equation;
$$R = [ \begin{matrix}{r}_{1 , 1} & {r}_{1 , 2} & K & {r}_{1 , {n}_{T}} \\ 0 & {r}_{2 , 2} & & M \\ M & O & O & {r}_{{n}_{T} - 1 , {n}_{T}} \\ 0 & K & 0 & {r}_{{n}_{T} , {n}_{T}}\end{matrix} ]$$
and, when c is vector composed of M nT×1 sized constellations ŝ is represented as the following equation;
$$\hat{s} = {\text{arg} min}_{c} ‖ {( {R}^{H} R )}^{- 1} {R}^{H} z - c ‖$$

9. The method according to claim 8, wherein X in the equation is predetermined in consideration of the performance and complexity of the system.

10. The method according to claim 8, wherein σ is a noise standard deviation and is defined by the following equation.
$$\frac{{E}_{b}}{{N}_{0}} = \frac{{n}_{R}}{b} \cdot \frac{{E}_{s}}{{N}_{0}}$$
where, the above equation represents the total received Eb/N0 per transmitting antenna, b is the required number of bits per symbol, and Eb and Es are energy per bit and symbol, respectively.

11. The method according to claim 1, wherein, at the i-th stage, the accumulated metric values of a set of new candidate symbols ([cX, cX′]) obtained through combination of a set of di−1 previous candidate symbols transferred from the previous stage and candidates of M i-th symbols (si) are calculated according to the following equation.

|zᵢ−Rₙ_{_{T}}_{-i+1,n}_{_{T}}_{-i+1:n}_{_{T}}[cₓ,c_{x′}]^{T}|²+E_{x′},
where 1≦x≦M, 1≦x′≦dᵢ₋₁
where, Rₙ_{_{T}}₋ᵢ₊1,n_{_{T}}₋ᵢ₊1:n_{_{I}} denotes vector with elements from the (nT−i+1)th to the (nT)th in the (nT−i+1)th row of R, and cX′ denotes a set of candidate symbols transferred from the previous stage.

12. The method according to claim 1, wherein the second threshold is determined based on an accumulated metric value of the path with the smallest accumulated metric in each state in consideration of a noise standard deviation.

13. The method according to claim 1, wherein the second threshold at the j-th state in the i-th stage is calculated according the following equation.
G_{i,j}=E_{(i,j),min}+Yσ
where, E(i,j),min is the smallest accumulated metric value of paths at the j-th state in the i-th stage.

14. The method according to claim 13, wherein Y in the equation is predetermined in consideration of the performance and complexity of the system.

15. The method according to claim 13, wherein σ is a noise standard deviation and is defined by the following equation.
$$\frac{{E}_{b}}{{N}_{0}} = \frac{{n}_{R}}{b} \cdot \frac{{E}_{s}}{{N}_{0}}$$
where, the above equation represents the total received Eb/N0 per transmitting antenna, b is the required number of bits per symbol, and Eb and Es are energy per bit and symbol, respectively.

16. The method according to claim 1, wherein the step of selecting paths having metric value smaller than the second threshold, as second surviving paths comprises the step of, if any path that satisfies the second threshold does not exist at a particular state, selecting paths with the smallest accumulated metric in the state, as the second surviving paths.

17. The method according to claim 1, wherein the step of selecting paths having metric value smaller than the second threshold, as second surviving paths comprises the step of, if the number of paths that satisfies the second threshold at a particular state is larger than the number of sub-metrics of the state, selecting paths in the state, as the second surviving paths by the number of sub-metrics in descending order of accumulated metrics in the state.
